(19) United States
(12) Patent Application Publication
(10) Pub. No.: US 2011/0078574 A1
(43) Pub. Date: Mar. 31, 2011

(54) SYSTEMS AND METHODS FOR THE CONFIGURATION AND MANAGEMENT OF INTELLIGENT ELECTRONIC DEVICES

(76) Inventors: David W. Bowe, Ajax (CA); Claudio Cargnelli, Toronto (CA); Robert Deveaux, Stouffville (CA); Brian Li, Toronto (CA); Wenhui Luo, Toronto (CA); Koh Shimizu, Toronto (CA)

(21) Appl. No.: 12/773,291

(22) Filed: May 4, 2010

Related U.S. Application Data
(60) Provisional application No. 61/245,785, filed on Sep. 25, 2009.

(51) Int. Cl. G06F 15/16; G06F 19/00; G06F 3/048

(52) U.S. Cl. 715/736; 702/34

(57) ABSTRACT

According to some embodiments, data may be received from a plurality of intelligent electronic devices (e.g., such as a set of protective relays). For each intelligent electronic device, status information may be stored based on the received data. Moreover, the status information may be displayed via a graphical user interface for the plurality of the intelligent electronic devices. The stored status information may also be transmitted to a remote central server via a communication network.

### CROSS-REFERENCE TO RELATED APPLICATION

This application is related to and claims the benefit of U.S. Provisional Application No. 61/245,785, filed Sep. 25, 2009 and titled SYSTEM AND METHODS FOR THE CONFIGURATION AND MANAGEMENT OF INTELLIGENT ELECTRONIC DEVICES, which is hereby incorporated by reference in its entirety for all purposes.

### BACKGROUND

In some systems, an operator or administrator may need to configure and manage a number of intelligent electronic devices. For example, a power system might include a number of relays, meters, and switches that need to be configured and managed. Each device may be “intelligent” in that that can determine and communicate information about itself (e.g., a serial number, a temperature level, or a hardware revision number). In addition, some types of devices may need to be periodically updated (e.g., when a new hardware revision is released for that particular device). Configuring and managing such devices may require investigation and can be a difficult task, especially when the system includes a relatively large number of devices.

Moreover, devices in a system may need to be replaced. For example, a device might need to be replaced after it has been installed or used for a pre-determined period of time (e.g., a recommend lifespan for the device). In other cases, a device might need to be replaced when its efficiency drops below a pre-determined level. Tracking and replacing many different type of devices for different reasons can be a time consuming process.

Further, an administrator or operator may need to maintain documents associated with the intelligent electronic device. For example, operating manuals, service bulletins, and product specifications may be released and/or updated by a manufacturer from time to time. Maintaining a complete and current library of documents for a set of intelligent electronic devices can also be relatively difficult task.

### SUMMARY

According to some embodiments, a communication device receives data from a plurality of intelligent electronic devices. A processor is coupled to the communication device, and a storage device is in communication with the processor and stores instructions adapted to be executed by the processor. The processor may then, for each intelligent electronic device, store status information based on the received data. The processor may also display, via a graphical user interface, status information for the plurality of the intelligent electronic devices. According to some embodiments, the processor may transmit the stored status information to a remote central server via a communication network.

Other embodiments may include: means for receiving data from a plurality of remote intelligent electronic devices; means for storing into a local database status information based on the received data for each intelligent electronic device; means for displaying, via a graphical user interface, status information for the plurality of the intelligent electronic devices; means for transmitting the stored status information to a remote central server via a communication network; means for automatically monitoring, by a processor, the status information for the plurality of remote intelligent electronic devices; and means for providing to a user a combined indication representing the plurality of remote intelligent electronic devices.

Yet other embodiments may be associated with receiving data from a plurality of remote power devices. For each power device, status information may be stored into a local database based oh the received data. Status information may also be displayed to a user and/or be transmitted to a remote central server via a communication network. The status information may be automatically monitored for the plurality of power devices, and a combined indication representing the plurality of power devices may be provided to a user.

A technical effect of some embodiments of the invention is an improved and automated ability to configure and manage intelligent electronic devices. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block level diagram of a system according to some embodiments.

FIG. 2 illustrates a method according to some embodiments of the present invention.

FIG. 3 illustrates a toolset application graphical user interface according to some embodiments.

FIG. 4 is a block diagram of a power configuration and management system in accordance with some embodiments.

FIG. 5 is a block diagram of a toolset application apparatus in accordance with some embodiments of the present invention.

FIG. 6 is a tabular view of a portion of a device database in accordance with some embodiments of the present invention.

### DETAILED DESCRIPTION

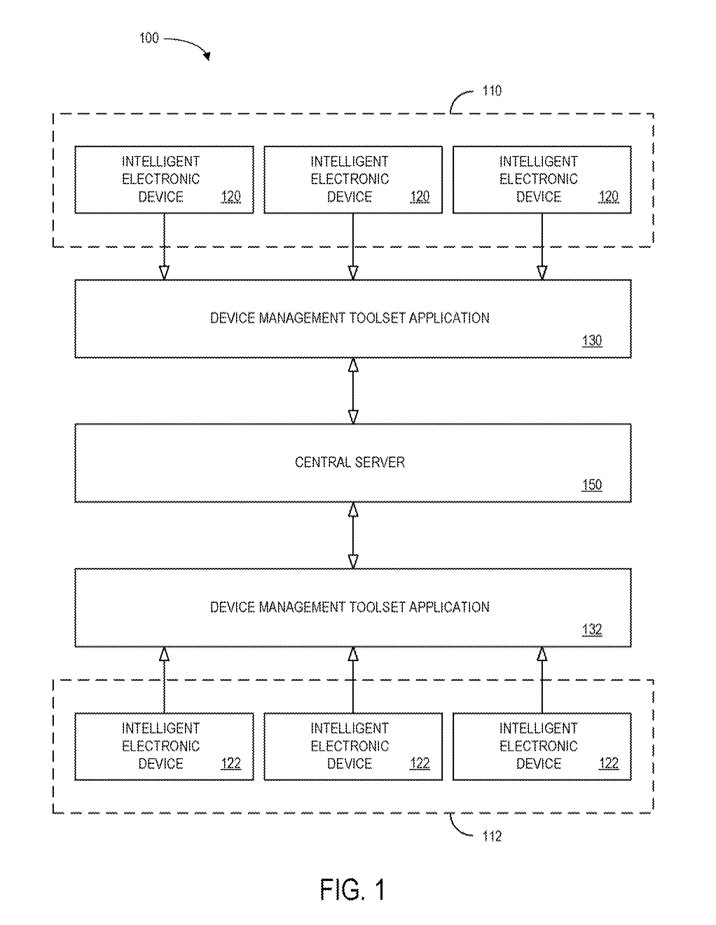

To address some of the problems described in the background section of this application, a device management toolset application and/or apparatus may be provided. For example, FIG. 1 is block diagram of a system 100 in accordance with some embodiments. In particular, a device management toolset application 130 may receive information from a first set 110 of intelligent electronic devices 120. The device management toolset application 130 may also exchange data with a remote central server 150. As used herein, a device may be “remote” from the device management toolset application 130 in that it is physically located distant from the device management toolset application 130 and/or in that it communicates with the device management toolset application 130 via one or more communication networks. The device management toolset application 130, intelligent electronic devices 120, and remote central server 150 may then operate in accordance with any of the embodiments described herein.

According to some embodiments, the device management toolset application 130, intelligent electronic devices 120, and remote central server 150 facilitate an automated configuration and/or management process. As used herein the term “automated” indicates that at least some part of a step associated with a process or service is performed with little or no human intervention. By way of examples only, the intelligent electronic devices 120 might be associated with a protective relay, a power meter, and/or a switch such as Multilin® devices available from General Electric Corporation®. The device management toolset application 130 might be associated with a Personal Computer (PC), a notebook computer, a workstation, and/or a Personal Digital Assistant (PDA). The central server 150 might be associated with, for example, a server and/or a database.

Any of the devices described in connection with the system 100 might, according to some embodiments, exchange information via a communication network. As used herein, devices (including those associated with the device management toolset application 130, intelligent electronic devices 120, and remote central server 150) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, an Ethernet network, a wireless LAN network, and/or an Internet Protocol (IP) network such as the Internet, an intranet, or an extranet. Note that any devices described herein may communicate via one or more such communication networks.

The devices of FIG. 1 might, according to some embodiments, be accessible via a Graphical User Interface (GUI). The GUI might be associated with the device management toolset application and may be used, for example, to dynamically display and receive information in connection with the intelligent electronic devices 120.

Although a single device management toolset application 130 for the first set 110 of intelligent electronic devices 120 (and a single central server 150) is shown in FIG. 1, any number of such devices may be included. Moreover, various devices described herein might be combined or co-located according to embodiments of the present invention.

The device management toolset application 130 may include a communication device (e.g., a port) to receive data from the plurality of intelligent electronic devices 120. According to some embodiments, the device management toolset application 130 may poll specific address to monitor the intelligent electronic devices 120 (e.g., using the Modbus protocol).

The device management toolset application 130 may further include a processor coupled to the communication device and a storage device in communication with the processor storing instructions adapted to be executed by the processor to perform a method in accordance with any of the embodiments described herein. For example, the device management toolset application 130 may, for each intelligent electronic device 120, store status information based on the received data and display, via a GUI, status information for the plurality of the intelligent electronic devices 120. The device management toolset application 130 may also transmit some or all of the stored status information to the remote central server 150 via a communication network.

Note that the central server 150 may exchange information with a number of different device management toolset applications (each associated with a different set of intelligent electronic devices). For example, FIG. 1 illustrates a second device management toolset application 132, associated with a second set 112 of intelligent electronic devices 122, which may also exchange information with the central server 150. In this way, the central server 150 may determine devices that should be recalled, upgraded, and/or receive service bulletins in connection with a number of different sets of devices.

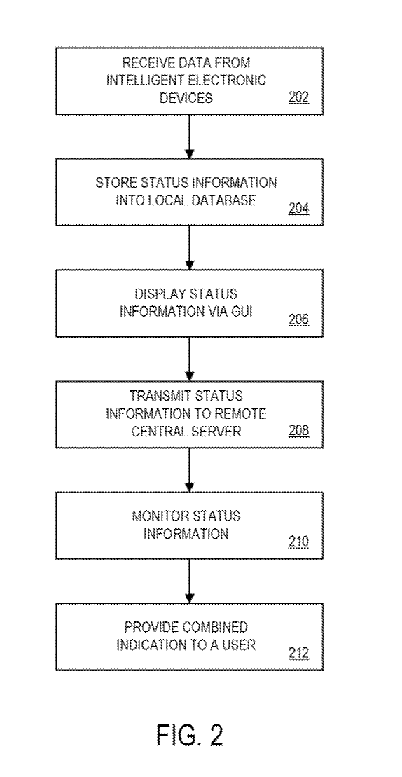

FIG. 2 illustrates one method that might be performed, for example, by the device management toolset application 130 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, data may be received from a plurality of intelligent electronic devices. The devices may be, for example, relays, meters, and/or switches (e.g., having digital signal processors) that are remote or co-located with a toolset application. At 204, status information may be stored for each intelligent electronic device based on the received data. The status information might, for example, include a serial number, an age of an intelligent electronic device, or a hardware revision identifier. According to some embodiments, the status information is stored into a local database or table.

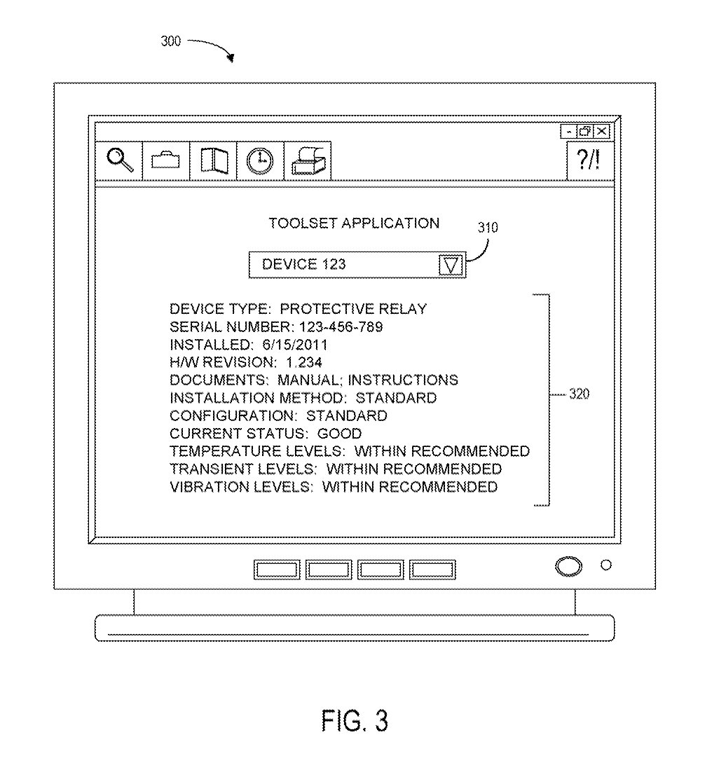

At 206, status information may be displayed via a GUI for the plurality of the intelligent electronic devices. By way of example only. FIG. 3 illustrates a toolset application GUI display 300 according to some embodiments. In particular, the display 300 might include a first area 310 where a user may enter or select a particular device identifier (e.g., “device 123”). The display 300 might also include a second area 320 where detailed information about the device can be provided to an administrator or operator (e.g., including a current status and a list of documents, such as manuals, that are available for the selected device).

Referring again to FIG. 2, the stored status information may be transmitted at 208 to a remote central server via a communication network. The transmitting might be associated with, for example, the Internet, a web site, Hypertext Transfer Protocol (HTTP) messages, and/or Hypertext Mark-Up Language (HTML) messages.

At 210, a processor may automatically monitor the status information for the plurality of remote intelligent electronic devices. For example, a toolset application might periodically check configuration information, installation methods, and/or the ages of devices in a power management system. At 212, a combined indication may be provided to a user. The combined indication might represent, for example, the current status of the plurality of remote intelligent electronic devices, an overall system health, and/or a security risk. According to some embodiments, the combined indication provides a representation and feedback showing the health status and security status for a number of different categories (and may be an instant overview of how devices are currently configured to help protect the assets of the system).

According to some embodiments, a toolset application may receive additional information from the central server in connection with at least one of the intelligent electronic devices. The additional information might, for example, be associated with a document for a device, a service bulletin, a product advisory, and/or a recommendation associated with an expected lifespan of the intelligent electronic device. According to some embodiments, the additional information comprises a notification that may be pushed through a web link from the central server based on an effectiveness of an intelligent electronic device. Note that the toolset application may further generate other notifications to facilitate the configuration and management of the intelligent electronic devices. Such an approach may help an operator or administrator proactively create a plan to replace outdated equipment and may reduce a number of customer support requests associated with the system.

In some cases, a toolset application may further generate one or more reports for a user. For example, a report might include a prioritized list of intelligent electronic devices that should be replaced or upgraded. According to some embodiments, a report might include an estimate of a lifespan based on at least one of: (i) an age of the intelligent electronic device, (ii) a total time installed, (iii) an operating environment, (iv) temperature information, (v) electrical transient levels, and/or (vi) vibration levels

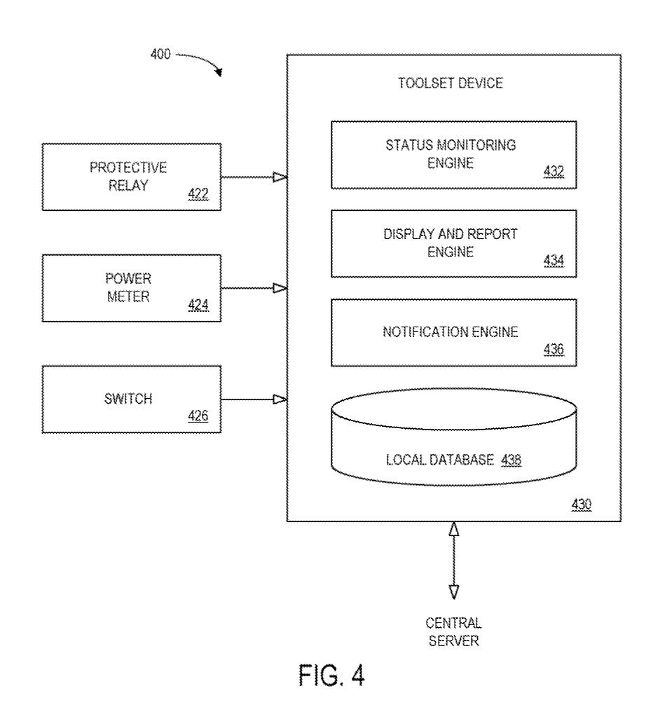

FIG. 4 is a block diagram of a power configuration and management system 400 in accordance with some embodiments. In this example, a toolset device 430 may receive information from a protective relay 422, a power meter 424, and a switch 426. The toolset device 430 may also exchange data with a remote central server 450 (not illustrated in FIG. 4). The toolset device 430, devices 422, 424, 426, and remote central server may then operate in accordance with any of the embodiments described herein.

For example, according to some embodiments, the toolset device 430, devices 422, 424, 426, and remote central server facilitate an automated configuration and/or management process. The toolset device 430 might be associated with a PC, a notebook computer, or a PDA.

The toolset device 430 may further include a processor coupled to the communication device and a storage device in communication with the processor storing instructions adapted to be executed by the processor to perform a method in accordance with any of the embodiments described herein. For example, the toolset device 430 may, for each intelligent electronic device 422, 424, 426, store status information into a local database 438 based on the received data. The toolset device 430 may include a status monitoring engine 432 that evaluates the status information in the local database 438 (e.g., to monitor the current status of the devices 422, 424, 426 and/or the overall health of the system). According to some embodiments, the status monitoring engine 432 may include diagnostic functions to detect faults (e.g., associated with waveform fault analysis, harmonic analysis, and/or phasor diagram viewers)

The toolset device 430 might also include a display and report engine 434 to facilitate a presentation of a GUI that dynamically displays and receives information in connection with the devices 422, 424, 426. The display and report engine 434 might also facilitate the generation of reports associated with at least one of the devices 422, 424, 426. The reports might, for example, include an estimate of a lifespan remaining for at least one of the devices 422, 424, 426 and may be generated based on an age of the device, a total time installed, an operating environment, temperature information, electrical transient levels, and/or vibration levels.

The toolset device 430 may also, according to some embodiments, include a notification engine 436. The notification engine 436 might, for example, transmit an email or other type of alert based on the current status of the system 400 and/or based on information received from the central server (e.g., indicating that a newly revised manual is available for one of the devices 422, 424, 426). As other examples, notifications might be transmitted when drawings, application notes, firmware updates, and/or brochures are issued for support documents and software tools. As another approach, some or all of this information might be automatically downloaded from the central server to the toolset device when it becomes available. In this way, all necessary documents, setup programs, and software tools may be automatically up to date and represent a complete reference library for the devices 422, 424, 426.

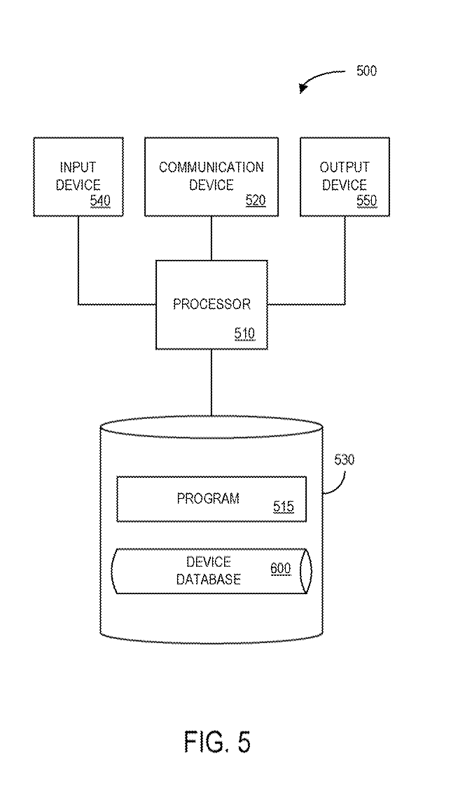

FIG. 5 is a block diagram of a toolset application apparatus 500 in accordance with some embodiments of the present invention. The apparatus 500 might, for example, comprise a platform or engine similar to the central litigation management system server 110 illustrated in FIG. 1. The apparatus 500 comprises a processor 510, such as one or more INTEL® Pentium® processors, coupled to a communication device 520 configured to communicate via a communication network (not shown in FIG. 5). The communication device 520 may be used to exchange information with intelligent electronic devices and/or a central server.

The processor 510 is also in communication with an input device 540. The input device 540 may comprise, for example, a keyboard, a mouse, or computer media reader. Such an input device 540 may be used, for example, to enter configuration and/or management information about intelligent electronic devices. The processor 510 is also in communication with an output device 550. The output device 550 may comprise, for example, a display screen or printer. Such an output device 550 may be used, for example, to provide reports and/or display information associated with intelligent electronic devices.

The processor 510 is also in communication with a storage device 530. The storage device 530 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 530 stores a program 515 for controlling the processor 510. The processor 510 performs instructions of the program 515, and thereby operates in accordance any embodiments of the present invention described herein. For example, the processor 510 may receive data from a plurality of intelligent electronic devices (e.g., such as a set of protective relays). For each intelligent electronic device, the processor 510 may store status information into a device database 600 based on the received data. Moreover, the processor 510 may facilitate a display of the status information via a GUI and/or arrange for the status information to be transmitted to a remote central server (e.g., via the communication device 520).

As used herein, information may be “received” by or “transmitted” to, for example: (i) the toolset application apparatus 500 from other devices; or (ii) a software application or module within the toolset application apparatus 500 from another software application, module, or any other source.

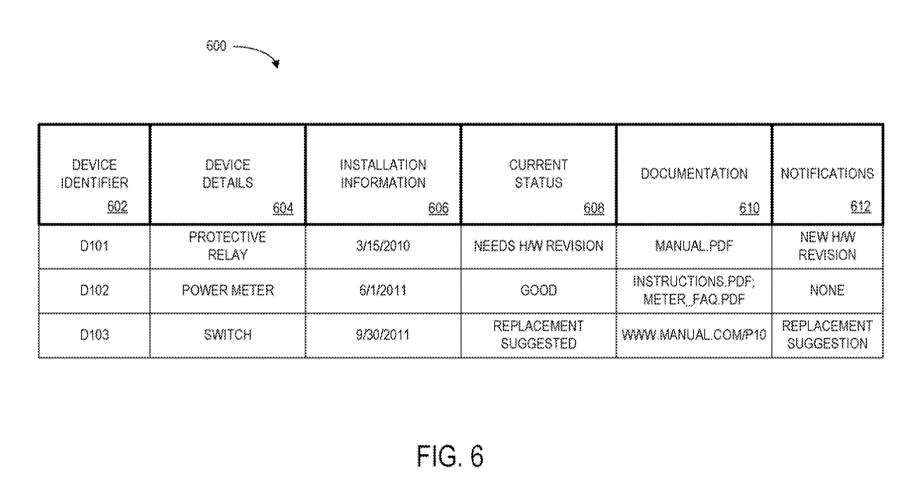

As shown in FIG. 5, the storage device 530 also stores the device database 600. One example of such a database 600 that may be used in connection with the toolset application apparatus 500 will now be described in detail with respect to FIG. 6. The illustration and accompanying descriptions of the database presented herein are exemplary, and any number of other database arrangements could be employed besides those suggested by the figures. For example, different databases associated with different types of intelligent electronic devices might be stored at the apparatus 500.

FIG. 6 is a tabular view of a portion of the device database 600 in accordance with some embodiments of the present invention. The table includes entries associated with intelligent electronic devices. The table also defines fields 602, 604, 606, 608, 610, 612 for each of the entries. The fields specify: a device identifier 602, device details 604, installation information 606, a current status 608, documentation 610, and notifications 612. The information in the database 600 may be periodically created and updated based on information received from intelligent electronic devices and/or a central server.

The device identifier 602 might be, for example, an alphanumeric code that uniquely identifies an intelligent electronic device, such as a power relay, meter, or switch. The device details 604 may store additional information about the device (e.g., associated with the devices function, serial number, or current hardware revision number). The installation information 606 might indicate when the device was installed (e.g., to help estimate when the device needs to be replaced) and the current status 608 might indicate an actual or estimated health of the device.

The documentation 610 might store documents, or pointers to documents, associated with the device (e.g., including manuals, specifications, and/or operating instructions for the device). The notifications 612 might store email or other types of notifications that need to be (or already have been) transmitted to an operator or administrator of a power system.

As a result of the embodiments described herein, the efficiency and accuracy associated with configuring and/or managing intelligent electronic devices may be improved for a system operator or administrator.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and engines described herein may be split, combined, and/or handled by external systems).

Applicants have discovered that embodiments described herein may be particularly useful in connection with power systems, although embodiments may be used in connection other types of systems that include multiple intelligent electronic devices.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A monitoring apparatus, comprising:
a communication device to receive data from a plurality of intelligent electronic devices;
a processor coupled to the communication device; and
a storage device in communication with said processor and storing instructions adapted to be executed by said processor to:
for each intelligent electronic device, store status information based on the received data,
display, via a graphical user interface, status information for the plurality of the intelligent electronic devices, and
transmit the stored status information to a remote central server via a communication network.

2. The apparatus of claim 1, wherein at least one of the intelligent electronic devices comprises: (i) a protective relay, (ii) a power meter, or (iii) an Ethernet switch.

3. The apparatus of claim 2, wherein the status information includes at least one of: (i) a serial number, (ii) an age of an intelligent electronic device, or (iii) a hardware revision identifier.

4. The apparatus of claim 2, wherein said transmitting is associated with at least one of: (i) the Internet, (ii) a web site, (iii) hypertext transfer protocol, or (iv) hypertext mark-up language.

5. The apparatus of claim 1, wherein the storage device further stores instructions adapted to be executed by said processor to:
monitor the status information for the plurality of remote intelligent electronic devices, and
provide a combined indication representing the plurality of remote intelligent electronic devices.

6. The apparatus of claim 5, wherein the monitored status information includes at least one of: (i) configuration information, (ii) an installation method, or (iii) an age of a device.

7. The apparatus of claim 5, wherein the combined indication is associated with at least one of: (i) an overall system health, (ii) a current status, or (iii) a security risk.

8. The apparatus of claim 1, wherein the storage device further stores instructions adapted to be executed by said processor to:
receive additional information from the central server in connection with at least one of the intelligent electronic devices.

9. The apparatus of claim 8, wherein the additional information comprises at least one of: (i) a document, (ii) a service bulletin, (iii) a product advisory, or (iv) a recommendation associated with an expected lifespan of the intelligent electronic device.

10. The apparatus of claim 9, wherein the additional information comprises a notification pushed through a web link from the central server based on an effectiveness of an intelligent electronic device.

11. The apparatus of claim 1, wherein the storage device further stores instructions adapted to be executed by said processor to:
generate a report associated with at least one of the intelligent electronic devices.

12. The apparatus of claim 11, wherein the report includes an estimate of a lifespan remaining for a first intelligent electronic device and is generated based on at least one of: (i) an age of the first intelligent electronic device, (ii) a total time installed of the first intelligent electronic device, (iii) an operating environment, (iv) temperature information, (v) electrical transient levels, or (vi) vibration levels.

13. The apparatus of claim 12, wherein the storage device further stores instructions adapted to be executed by said processor to configure and manage the intelligent electronic devices.

14. The apparatus of claim 12, wherein the report includes a prioritized list of intelligent electronic devices that should be replaced or upgraded.

15. A computer-implemented method, comprising:
receiving data from a plurality of remote intelligent electronic devices;
for each intelligent electronic device, storing into a local database status information based on the received data;
displaying, via a graphical user interface, status information for the plurality of the intelligent electronic devices;
transmitting the stored status information to a remote central server via a communication network;
automatically monitoring, by a processor, the status information for the plurality of remote intelligent electronic devices; and
providing to a user a combined indication representing the plurality of remote intelligent electronic devices.

16. The method of claim 15, wherein at least one of the intelligent electronic devices comprises: (i) a protective relay, (ii) a power meter, or (iii) an Ethernet switch.

17. The method of claim 15, further comprising:
automatically outputting a report associated with at least one of the intelligent electronic devices, including an estimate of a lifespan based on at least one of (i) an age of the intelligent electronic device, (ii) a total time installed, (iii) an operating environment, (iv) temperature information, (v) electrical transient levels, or (vi) vibration levels.

18. A computer-readable medium storing instructions adapted to be executed by a processor to perform a method, said method comprising:
receive data from a plurality of remote power devices;
for each power device, store into a local database status information based on the received data;
display to a user status information for the plurality of power devices;
transmit the stored status information to a remote central server via a communication network;
automatically monitor the status information for the plurality of power devices; and
provide to the user a combined indication representing the plurality of power devices.

19. The medium of claim 18, wherein at least one of the power devices comprises: (i) a protective relay, (ii) a power meter, or (iii) an Ethernet switch.

20. The medium of claim 18, wherein the medium further stores instructions adapted to be executed by a processor to automatically create a report associated with at least one of the power devices, including an estimate of a lifespan based at least in part on: (i) an age of the power device, (ii) a total time installed of the power device, (iii) an operating environment, (iv) temperature information, (v) electrical transient levels, or (vi) vibration levels.
